(19) United States
(12) Patent Application Publication
(10) Pub. No.: US 2007/0120651 A1
(43) Pub. Date: May 31, 2007

(54) RFID tag system and data processing method executed by RFID tag system

(76) Inventors: Yuichi Kobayashi, Sagamihara (JP); Toshiyuki Kuwana, Yokohama (JP); Atsushi Honzawa, Kawasaki (JP); Shinichiro Fukushima, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/442,281

(22) Filed: May 30, 2006

(30) Foreign Application Priority Data
Nov. 29, 2005 (JP) 2005-344012

(51) Int. Cl. H04Q 5/22

(52) U.S. Cl. 340/10.51; 340/572.1

(57) ABSTRACT

In order to provide a highly secure system at a low cost without providing a complicated logic circuit for an RFID tag, in a system including an RFID tag (10) and a interrogator (20), the interrogator (10) is provided with a password creating unit (1100) which computes an electronic key (131) and a keyword unique to the RFID tag with a predetermined irreversible function to create a password. By using the password as a key, item information of an item attached with the RFID tag (20) is encrypted with a predetermined encryption function. The encrypted item information and the keyword are written to the RFID tag (20). The interrogator (10) reads the encrypted item information and the keyword from the RFID tag (20), causes the password creating unit (1100) to compute the password by using the keyword, and uses the password as a key to decrypt the read encrypted item information.

### BACKGROUND OF THE INVENTION

The present invention relates to a technique for a system including an RFID tag and an information processing device which reads/writes data from/to the RFID tag and the like, in particular, a technique of ensuring security of data to be stored in the RFID tag (RFID: Radio Frequency Identification).

In recent years, introduction of an RFID tag system has been promoted. In the RFID tag system, an RFID tag including a memory which stores item information and the like is attached to an item. The information is read from the RFID tag by a interrogator to manage the item or to check the location of the item. For example, in a distribution industry, there has been introduced the RFID tag system, in which an RFID tag that stores information on a food product indicating a producer thereof and a cultivation method is attached to the food product, and the information stored in the RFID tag is read by a interrogator to display the information. In a publishing field, the use of the RFID tag system is now under examination for the purposes of preventing a fraud, improving the efficiency of physical distribution, inventory control and the like.

In the RFID tag system, there is a fear that a user privacy protection issue may arise. For example, if an RFID tag is present with an item even after a consumer acquires the item, the use of a interrogator allows access to the memory in the RFID tag from a remote location to easily read the information in the memory. As a result, it is possible to know the belongings of the consumer who owns the item without being noticed by the consumer. Therefore, there is a high possibility of the invasion of consumer privacy.

In order to cope with the privacy matter described above, Japanese Patent No. 3027791 (hereinafter, referred to as Patent Document 1) realizes the enhancement of security of a processing on an authenticating side in the following manner. For authentication of an authentication requestor (for example, a interrogator), after a processing unit for encryption/decryption or the like is provided for the authenticating side (for example, an RFID tag) to verify the authentication requestor, the authenticating side performs a certain processing (for example, transmission of information in a memory). In Japanese Patent Laid-open Publication No. 2004-318478 (hereinafter, referred to as Patent Document 2), an encryption processing is performed outside an RFID tag to write encrypted information in a memory of the RFID tag, thereby realizing the enhancement of safety of information in the memory.

However, Patent Document 1 has the following disadvantage. To be more specific, the processing section for encryption/decryption or the like is required to be provided for the RFID tag to carry out the technique described in Patent Document 1, resulting in a high unit cost per RFID tag. Therefore, the attachment of the RFID tag to each item is not practical in view of cost.

On the other hand, although Patent Document 2 can realize the reduction in cost of the RFID tag, there arises another problem of inconvenience in operation because an ID associated with information of the owner of the RFID tag is required to be issued and managed for each RFID tag. To be more specific, according to Patent Document 2, data encrypted based on the ID associated with information of the owner of the RFID tag is stored in the RFID tag. Unless the ID of the owner is input, the encrypted data cannot be decrypted. Therefore, it is troublesome because the owner is required to be specified prior to the writing of data to the RFID tag. Furthermore, in Patent Document 2, since the ID is required to be input for reading information from the RFID tag, the operation is complicated.

### SUMMARY OF THE INVENTION

The present invention has been made in view of the above-described circumstance and has an object of providing a highly secure RFID tag system at low cost without providing a complicated logic circuit in an RFID tag.

In order to solve the problem discussed above, an embodiment according to the present invention is applied to an RFID tag system including an RFID tag including a memory which stores data and a interrogator which writes/reads data to/from the memory of the RFID tag.

The RFID tag includes a first transmitting/receiving unit which transmits/receives data to/from the interrogator and a first control unit which accepts various commands from the interrogator through the first transmitting/receiving unit to perform a processing corresponding to the accepted commands. The interrogator includes: a password creating unit which computes a prestored electronic key and a keyword unique to the RFID tag with a predetermined irreversible function to create a password; an encryption processing unit which uses the password as a parameter to encrypt information regarding a target (target information) attached with the RFID tag by using a predetermined encryption function; a decryption processing unit which uses the password as a parameter to decrypt the encrypted target information by using a predetermined decryption function corresponding to the predetermined encryption function; a second transmitting/receiving unit which transmits/receives the data to/from the RFID tag; and a second control unit which transmits various commands to the RFID tag through the second transmitting/receiving unit to perform a processing which reads/writes the data from/to the memory of the RFID tag and a processing which invalidates the RFID tag.

The second control unit of the interrogator writes the encrypted target information and the keyword unique to the RFID tag to the memory of the RFID tag, reads the encrypted target information and the keyword unique to the RFID tag written in the memory of the RFID tag, causes the password creating unit to create the password by using the read keyword and the electronic key, and causes the decryption processing unit to decrypt the read encrypted target information into plaintext target information by using the created password.

As described above, according to the present invention, the encrypted information and the keyword for creating a password for a decryption processing of the encrypted information are written in the RFID tag. The interrogator reads the keyword and the encrypted information from the RFID tag, creates the password using the keyword and the electronic key, and then decrypts the encrypted information using the created password. Therefore, the present invention does not require the RFID tag to be provided with a processing section for processing encryption and decryption, thereby realizing a highly secure RFID tag system at low cost.

According to the present invention, it is not necessary to issue and manage an ID associated with information of an owner of the RFID tag. Furthermore, a user is not required to perform an operation of inputting an ID for decryption. Therefore, in the present invention, a burden of operation on the user of the RFID tag or a burden of work on a system manager can be reduced.

### BRIEF DESCRIPTION OF THE DRAWINGS

In the accompanying drawings:

FIG. 1 is a functional block diagram of an RFID tag system according to a first embodiment of the present invention;

FIG. 2 is a hardware configuration diagram of the RFID tag system according to the first embodiment of the present invention;

FIG. 3 is a flowchart of a processing in a preliminary stage, which is executed by a interrogator, according to the first embodiment of the present invention;

FIG. 4 is a flowchart of a processing, in which the interrogator reads out and decrypts encrypted RFID tag information from an RFID tag, according to the first embodiment of the present invention;

FIG. 5 is a functional block diagram of the RFID tag system according to a second embodiment of the present invention;

FIG. 6 is a flowchart of a processing in a preliminary stage, which is executed by the interrogator, according to the second embodiment of the present invention;

FIG. 7 is a flowchart for illustrating a data transmission/reception processing executed between the interrogator and the RFID tag according to the second embodiment of the present invention;

FIG. 8 is a flowchart for illustrating a processing which updates a keyword to be stored in the RFID tag, which is executed by the RFID tag system, according to a third embodiment of the present invention;

FIG. 9 is a flowchart for illustrating a processing which checks whether the keyword to be stored in the RFID tag has been updated or not for each time, according to a fourth embodiment of the present invention;

FIG. 10 is a functional block diagram of the RFID tag system according to a fifth embodiment of the present invention;

FIG. 11 shows a hardware configuration according to the fifth embodiment of the present invention;

FIG. 12 is a flowchart of a processing in a preliminary stage, which is executed by the interrogator, according to the fifth embodiment of the present invention; and

FIG. 13 is a flowchart for illustrating the data transmission/reception processing performed between the interrogator and the RFID tag according to the fifth embodiment of the present invention.

### DESCRIPTION OF THE PREFERRED EMBODIMENTS

Hereinafter, embodiments of the present invention will be described with reference to the accompanying drawings.

### First Embodiment

First, a first embodiment of the present invention will be described. The first embodiment describes a system which stores information encrypted with an individual password in an RFID tag (RFID: Radio Frequency Identification) and decrypts the encrypted information read from the RFID tag.

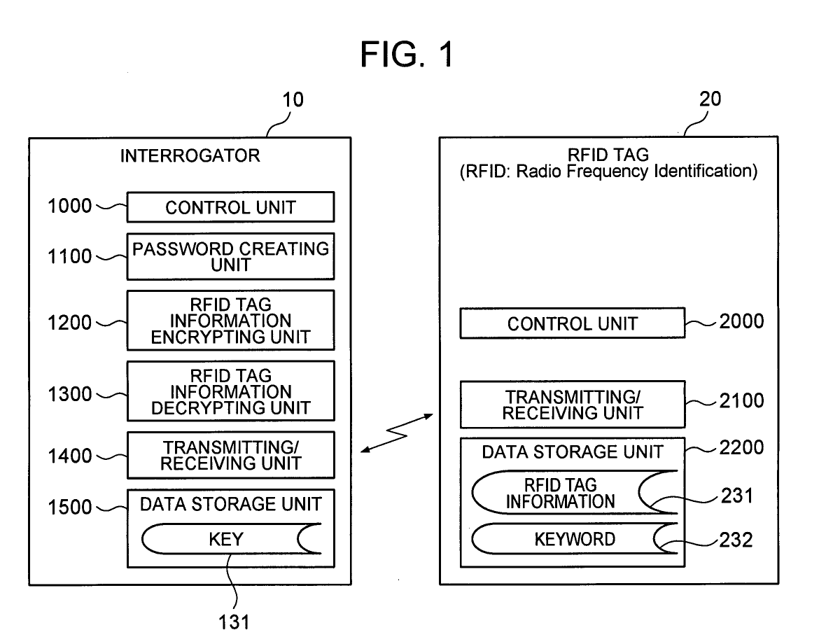

FIG. 1 is a functional block diagram of an RFID tag system according to the first embodiment of the present invention.

As illustrated, the RFID tag system includes an RFID tag 20 which stores data and performs a wireless communication and a interrogator 10 which wirelessly communicates with the RFID tag 20 to operate the RFID tag 20. The interrogator 10 may be a dedicated apparatus which performs a read processing and a write processing of data on the RFID tag such as the RF-ID tag and the like, or may be integrally formed with a personal computer, a cell phone, kiosk terminal equipment, an automatic vending machine or the like.

The RFID tag 20 is directly attached to an item such as a book, a clothing item or an electronic appliance or is attached to a package or a box for packing an item or the like. The RFID tag 20 may also be attached to a card carried by an individual. Either of or both of a plurality of RFID tags 20 and a plurality of interrogators 10 may be present.

To be specific, the interrogator 10 includes a control unit 1000, a password creating unit 1100, an RFID tag information encrypting unit 1200, an RFID tag information decrypting unit 1300, a transmitting/receiving unit 1400, and a data storage unit 1500 which stores various data such as a common key 131.

The control unit 1000 controls the operation of the entire interrogator 10. The control unit 1000 also performs a processing which writes data in the RFID tag 20, a processing which reads data from the RFID tag 20, and a processing which invalidates the RFID tag 20 through the transmitting/receiving unit 1400. To be specific, the control unit 1000 creates a command for writing data to the RFID tag 20 (a write command) and transmits the write command to the RFID tag 20 via the transmitting/receiving unit 1400. The control unit 1000 also creates a command for reading data from the RFID tag 20 (a read command) and transmits the created read command to the RFID tag 20 via the transmitting/receiving unit 1400. The control unit 1000 creates a command of invalidating the RFID tag 20 (an invalidation command) and transmits the created invalidation command to the RFID tag 20 via the transmitting/receiving unit 1400.

Furthermore, the control unit 1000 accepts inputs of various requests and data from a user through an input device (a keyboard, an operation panel or the like; not shown).

The password creating unit 1100 creates a password to be used for an encryption processing and a decryption processing. To be specific, the password creating unit 1100 computes the common key 131 stored in the data storage unit 1500 and a keyword unique to the RFID tag using an irreversible function H to create the password. The irreversible function H is not particularly limited; for example, a hash function may be used.

The RFID tag information encrypting unit 1200 encrypts information to be written to the RFID tag 20. To be specific, the RFID tag information encrypting unit 1200 encrypts RFID tag information with a reversible encryption function F using the password obtained by the computation of the password creating unit 1100 as a parameter. Although a specific encrypting method is not particularly limited in this embodiment, the case where the encryption processing and the decryption processing are performed with the same password (a common key encrypting method) is used will be described below as an example.

The RFID tag information decrypting unit 1300 decrypts the encrypted RFID tag information read from the RFID tag 20. To be specific, the RFID tag information decrypting unit 1300 decrypts the encrypted RFID tag information into plain text RFID tag information by a decryption function G corresponding to the reversible encryption function F using the password obtained by the computation of the password creating unit 1100 as a parameter.

The transmitting/receiving unit 1400 controls the transmission and reception of data performed with respect to the RFID tag 20. For example, the transmitting/receiving unit 1400 accesses the RFID tag 20 in response to a request from the control unit 1000 to receive the encrypted RFID tag information transmitted from the RFID tag 20.

Next, a functional configuration of the RFID tag 20 will be described. The RFID tag 20 includes a control unit 2000, a transmitting/receiving unit 2100 and a data storage unit 2200 which stores various information. The data storage unit 2200 stores encrypted RFID tag information 231 and a keyword 232 unique to the RFID tag 20.

The control unit 2000 controls the operation of the entire RFID tag. For example, the control unit 2000 receives the data write command from the interrogator 10 via the transmitting/receiving unit 2100 to store the data in the data storage unit 2200 in accordance with the data write command. The control unit 2000 receives the data read command from the interrogator 10 via the transmitting/receiving unit 2100 to transmit the data stored in the data storage unit 2000 to the interrogator 10 via the transmitting/receiving unit 2100 in accordance with the data read command.

The transmitting/receiving unit 2100 controls the transmission and reception of data with respect to the interrogator 10.

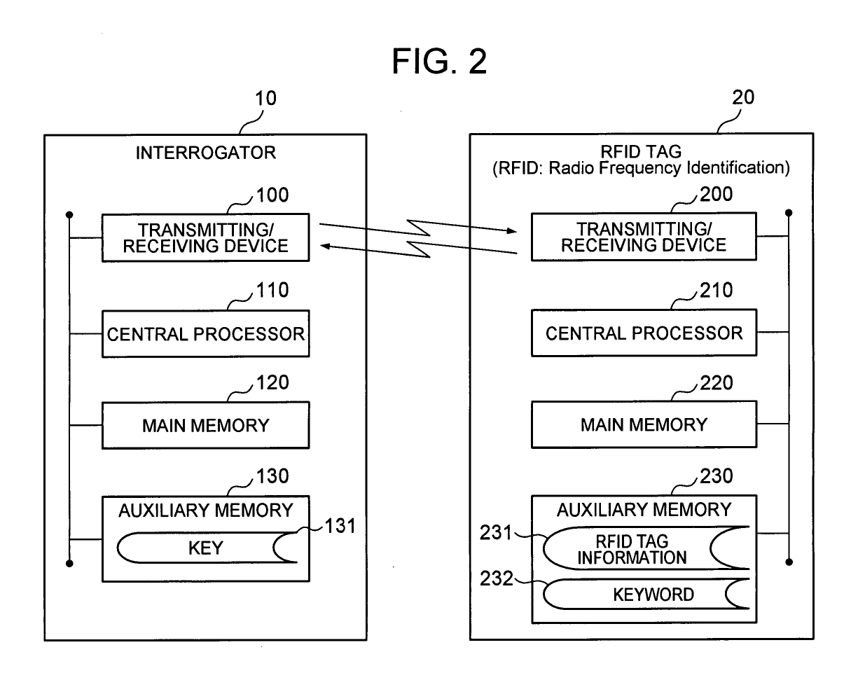

Subsequently, a hardware configuration of this embodiment will be described with reference to FIG. 2.

FIG. 2 is a hardware configuration diagram of the RFID tag system according to the first embodiment of the present invention.

The interrogator 10 includes: a transmitting/receiving device 100 which transmits/receives a signal to/from the RFID tag 20 in an electromagnetic induction method, a radio wave method, an optical communication method or the like; a central processor 110 such as a CPU, which processes data; a main memory 120 such as a RAM, which temporarily stores data; and an auxiliary memory 130 such as a ROM, which stores data with high tamper proofness. The transmitting/receiving device 100, the central processor 110, the main memory 120 and the auxiliary memory 130 are connected to each other through a bus or the like.

The auxiliary memory 130 stores the common key 131 necessary for creating the password by using the keyword 232 received from the RFID tag 20 and programs for realizing the functions of the control unit 1000, the password creating unit 1100, the RFID tag information encrypting unit 1200 and the RFID tag information decrypting unit 1300 described above.

The functions of the control unit 1000, the password creating unit 1100, the RFID tag information encrypting unit 1200 and the RFID tag information decrypting unit 1300 are realized by the central processor 110 which loads the above-mentioned programs stored in the auxiliary memory 130 onto the main memory 120 to execute the programs. The function of the transmitting/receiving unit 1400 is realized by the transmitting/receiving device 100. The function of the data storage unit 1500 is realized by the auxiliary memory 130.

The RFID tag 20 includes a transmitting/receiving device 200 which transmits/receives a signal to/from the interrogator 10 in the electromagnetic induction method, the radio wave method, the optical communication method or the like; a central processor 210 such as a CPU, which processes data; a main memory 220 such as a RAM, which temporarily stores data only when the power of the RFID tag 20 is on; and an auxiliary memory 230 such as an EEPROM, which stores data even when the power of the RFID tag 20 is off. The transmitting/receiving device 200, the central processor 210, the main memory 220 and the auxiliary memory 230 are connected to each other through a bus or the like.

The auxiliary memory 230 stores the RFID tag information 231 which explains an item to which the RFID tag 20 is attached, the unique keyword 232, and a control program for realizing the function of the control unit 2000 described above.

The function of the control unit 2000 is realized by the central processor 210 which loads the above-mentioned program stored in the auxiliary memory 230 onto the main memory 220 to execute the program. The function of the transmitting/receiving unit 2100 is realized by the transmitting/receiving device 200. The function of the data storage unit 2200 is realized by the auxiliary memory 230.

Next, a data transmission/reception processing performed between the interrogator 10 and the RFID tag 20 according to the first embodiment of the present invention will be described.

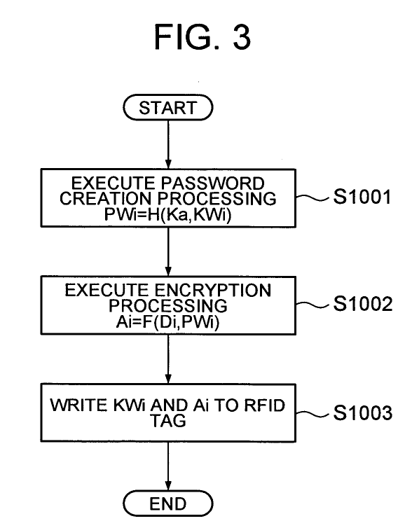

First, as a preliminary stage, a processing in which the interrogator 10 writes data to the RFID tag 20 (a preliminary stage processing) will be described with reference to FIG. 3.

FIG. 3 is a flowchart of a processing in which the interrogator 10 writes the RFID tag information to the RFID tag 20 according to the first embodiment of the present invention. The data storage unit 1500 of the interrogator 10 stores a common key Ka.

First, the interrogator 10 performs a processing which creates a password PWi used for the encryption processing and the decryption processing of the RFID tag information (S1001).

To be specific, the control unit 1000 of the interrogator 10 accepts the input of a keyword KWi unique to the RFID tag 20 and plaintext RFID tag information Di. The password creating unit 1100 computes the keyword KWi accepted by the control unit 1000 and the common key Ka stored in the data storage unit 1500 with the irreversible function H. The result of computation is obtained as the password PWi.

A method which allows the interrogator 10 to accept the input of the keyword KWi and the plaintext RFID tag information is not particularly limited. For example, a user may input the keyword KWi and the plaintext RFID tag information Di to the interrogator 10 through an input device (not shown). The RFID tag information is information of an item to which the RFID tag 20 is to be attached or the like (a product name, an item number, a price, date of manufacture, producer information and the like).

Next, the interrogator 10 performs a processing which encrypts the accepted RFID tag information Di (S1002). To be specific, the RFID tag information encrypting unit 1200 uses the password PWi created in S1001 as a parameter to compute the accepted RFID tag information Di with the reversible encryption function F for encryption. The result of encryption is obtained as encrypted RFID tag information Ai.

Next, the interrogator 10 transmits and writes the keyword KWi and the encrypted RFID tag information Ai obtained in S1002 to the RFID tag 20 (S1003). To be specific, the control unit 1000 writes the encrypted RFID tag information Ai encrypted by the RFID tag information encrypting unit 1200 and the keyword KWi to the RFID tag 20 through the transmission/reception control unit 1400.

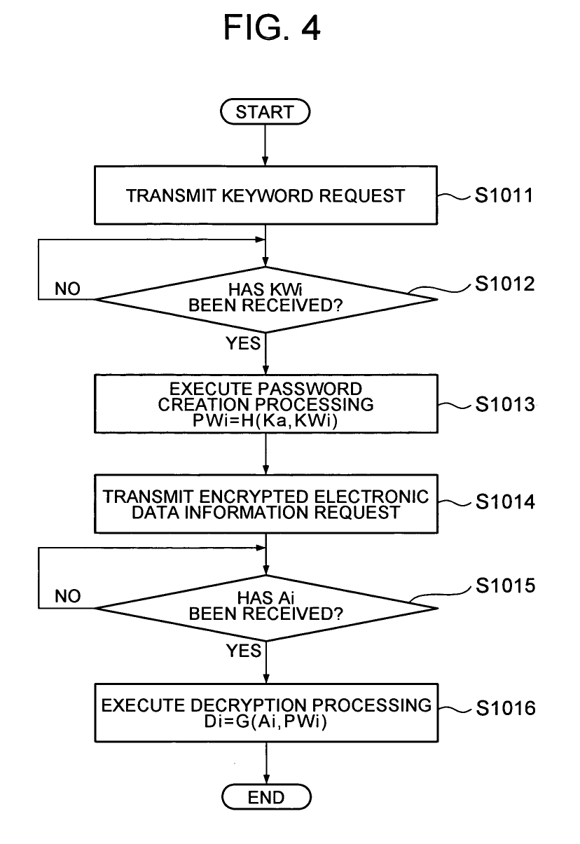

Subsequently, a processing performed by the interrogator 10, which reads the encrypted RFID tag information Ai stored in the RFID tag 20 to decrypt the read encrypted RFID tag information Ai, will be described with reference to FIG. 4.

FIG. 4 is a flowchart of a processing performed by the interrogator 10, which reads and decrypts the encrypted RFID tag information from the RFID tag 20, according to the first embodiment of the present invention. The illustrated flow is performed by the interrogator 10 different from the one which has written the encrypted RFID tag information Ai to the RFID tag 20 in the preliminary stage processing shown in FIG. 3.

The interrogator 10 which performs the flow shown in FIG. 4 stores the same common key Ka as that used in S1001 in FIG. 3. To be specific, the data storage unit 1500 of the interrogator 10 stores the common key Ka used in S1001. In this case, it is desirable to store the common key Ka to the limited interrogator 10 by using a tamper proof technique.

First, the interrogator 10 transmits a signal which requests the keyword to the RFID tag 20 (S1011) To be specific, the control unit 1000 transmits a signal that requests the keyword to the RFID tag 20 via the transmitting/receiving unit 1400.

Next, the interrogator 10 waits for the reception of a signal from the RFID tag 20 (S1012). To be specific, the control unit 1000 waits for the reception of a signal from the RFID tag 20. Upon reception of the keyword KWi, the control unit 1000 outputs the keyword KWi to the password creating unit 1100 and then proceeds to a processing in S1013.

In S1013, a processing which creates the password is performed. To be specific, the password creating unit 1100 computes the keyword KWi received in S1012 and the common key Ka stored in the data storage unit 1500 with the same irreversible function H as that used in S1001 in FIG. 3. The result of computation is obtained as the password PWi.

Next, the interrogator 10 transmits a signal which requests the encrypted electronic data information Ai (the read command) to the RFID tag 20 (S1014). To be specific, the control unit 1000 transmits a signal which requests the encrypted electronic data information Ai (the read command) to the RFID tag 20 via the transmitting/receiving unit 1400.

Thereafter, the interrogator 10 waits for reception of a signal from the RFID tag 20 (S1015). To be specific, the control unit 1000 waits for reception of a signal from the RFID tag 20. Upon reception of the encrypted RFID tag information Ai, the control unit 1000 outputs the encrypted RFID tag information Ai to the RFID tag information decrypting unit 1300 and then proceeds to a processing in S1016.

In S1016, a processing which decrypts the received encrypted RFID tag information Ai is performed. To be specific, the RFID tag information decrypting unit 1300 uses the password PWi derived in S1013 as a parameter to compute the received encrypted electronic data information Ai with the decrypting function G corresponding to the irreversible encryption function F in S1002 in FIG. 3, thereby decrypting the encrypted electronic data information Ai in the plaintext electronic data information Di.

By the above processing, the information encrypted with an individual password can be received from the RFID tag 20 to be decrypted.

Although the keyword KWi and the encrypted electronic data information Ai are obtained at different times in the flow shown in FIG. 4, it is a mere example. To be specific, although the keyword KWi is received in S1012 and the encrypted electronic data information Ai is received in S1015, the keyword KWi and the encrypted electronic data information Ai may be received at the same time. For example, the transmission of the keyword KWi and the encrypted electronic data information Ai may be requested in S1011, whereas both the keyword KWi and the encrypted electronic data information Ai may be received in S1012. In this case, the processings in S1014 and S1015 can be omitted. Even in this manner, the same effect as that of the above-described flow shown in FIG. 4 can be obtained.

As described above, in the first embodiment of the present invention, the keyword for creating the password used for decrypting the encrypted data is written with the encrypted data to the RFID tag 20. The interrogator 10 is made to store the common key necessary for creating the password. Then, the interrogator 10 reads out the keyword and the encrypted data from the RFID tag 20 to create the password by using the keyword and the common key. Thereafter, the interrogator 10 decrypts the encrypted data by using the created password.

To be specific, since a processing unit which performs a processing such as encryption or decryption is not required to be provided for the RFID tag 20 in the first embodiment, a highly secure RFID tag system can be realized at low cost.

Moreover, in the first embodiment, for reading the data from the RFID tag 20, the user is not required to input information such as a password or an ID to the interrogator 10. To be specific, in the first embodiment, it is not necessary to perform an operation of inputting an ID for causing the interrogator 10 to read the information from the RFID tag 20 as needed in the case of the above-described Patent Document 2. Therefore, according to the first embodiment, the security of data can be ensured. In addition, the usability of the user can be improved.

In the system in the above-described Patent Document 2 requires the user to request the system manager to issue and register an ID in advance, thereby complicating the operation. On the other hand, in the first embodiment, since it is not necessary to register the user, a burden on the manager can be reduced. As the number of users increases, the amount of data for managing the user ID and the key increases to increase also a processing load for searching for the key. As a result, cost on the side of the system which reads the data from the RFID tag 20 (the interrogator) increases (because high performance information processing ability is required). On the other hand, in the first embodiment, it is not necessary to manage the user ID and the key in an associated manner. Therefore, a problem does not occur even when the number of users increases.

### Second Embodiment

Next, a second embodiment of the present invention will be described. The second embodiment of the present invention employs a structure in which a function of an authentication processing is provided for the RFID tag 20. The RFID tag 20 is made to accept only a request from the authenticated interrogator 10 to prevent unauthorized access to the RFID tag 20. In the description of the second embodiment, the same reference numerals as those in the first embodiment described above are used for the same configuration. A part of the second embodiment, which is different from the first embodiment, will be mainly described.

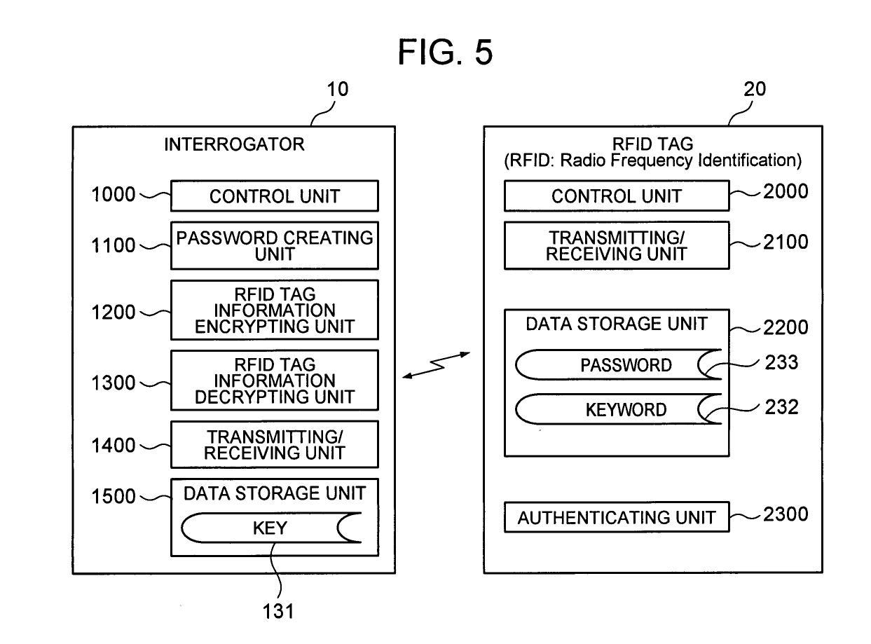

First, a functional configuration of the second embodiment will be described with reference to FIG. 5.

FIG. 5 is a functional block diagram of an RFID tag system according to the second embodiment of the present invention.

As illustrated, the RFID tag system in the second embodiment includes the interrogator 10 and the RFID tag 20 as in the above-described first embodiment.

The interrogator 10 according to the second embodiment employs the same configuration as that in the first embodiment except for a part of the function of the control unit 1000. Since the functional configuration of the interrogator 10 in the second embodiment has been described above, the description thereof is herein omitted. A processing performed by the control unit 1000 will be described below.

The RFID tag 20 in the second embodiment is obtained by adding an authenticating unit 2300 to the configuration in the first embodiment. The RFID tag 20 in the second embodiment differs from that in the first embodiment in a part of the function of the control unit 2000. To be specific, the RFID tag 20 includes the authenticating unit 2300 in addition to the control unit 2000, the transmitting/receiving unit 2100 and the data storage unit 2200 described above. The data storage unit 2200 stores the keyword 232 and the password 233. The authenticating unit 2300 compares a password transmitted from the interrogator 10 and the password 233 stored in the data storage unit 2200 with each other to authenticate the interrogator 10. The control unit 2000 accepts only a request from the authenticated interrogator 10.

A hardware configuration of the RFID tag system in the second embodiment is the same as that shown in FIG. 2 above. The auxiliary memory 230 of the RFID tag 20 stores an authentication program which realizes a function of the authenticating unit 2300. The function of the authenticating unit 2300 is realized by the central processor 210 that loads the above-described authentication program stored in the auxiliary memory 230 to the main memory 220 and executes the program.

Next, a data transmission/reception processing performed between the interrogator 10 and the RFID tag 20 according to the second embodiment will be described.

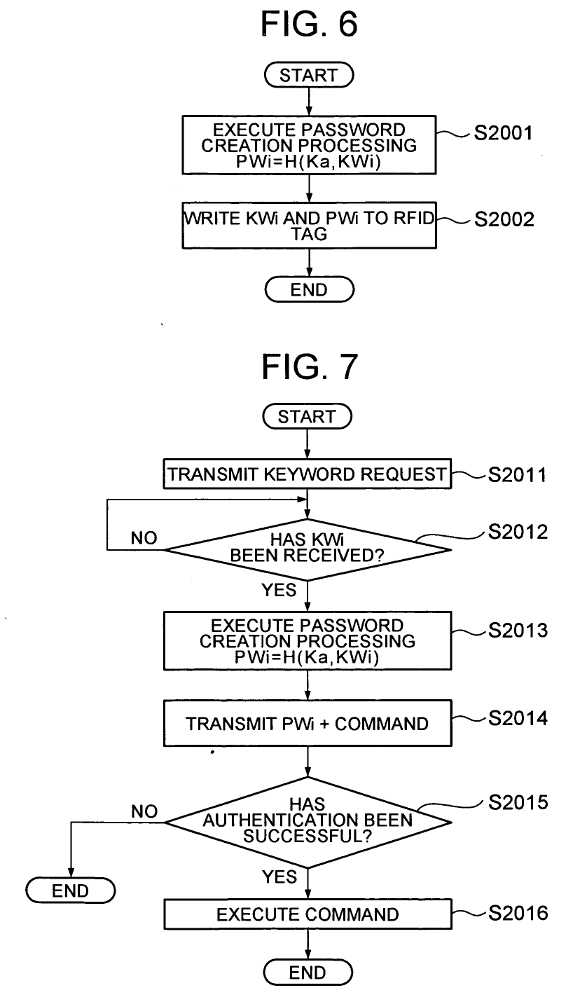

First, a processing, in which the interrogator 10 writes the keyword KWi and the password PWi to the RFID tag 20 as a preliminary stage (a preliminary stage processing), will be described with reference to FIG. 6.

FIG. 6 is a flowchart of the preliminary stage processing executed by the interrogator 10 according to the second embodiment of the present invention.

First, in accordance with the same procedure as that in S1001 shown in FIG. 3 above, the interrogator 10 performs a processing which creates the password PWi used for the encryption processing and the decryption processing of the RFID tag information (S2001).

Next, the control unit 1000 of the interrogator 10 transmits and writes the keyword KWi and the password PWi obtained in S2001 to the RFID tag 20 (S2002).

Subsequently, a processing, in which the interrogator 10 operates the RFID tag 20 according to the second embodiment, will be described with reference to FIG. 7.

FIG. 7 is a flowchart for explaining the data transmission/reception processing performed between the interrogator 10 and the RFID tag 20 according to the second embodiment.

The illustrated flow is performed by the interrogator 10 different from the one which has written the password PWi and the keyword KWi to the RFID tag 20 in the preliminary stage processing shown in FIG. 6.

The interrogator 10 which performs the flow shown in FIG. 7 stores the same common key Ka as that used in S2001 in FIG. 6. To be specific, the data storage unit 1500 of the interrogator 10 stores the common key Ka used in S2001. In this case, it is desirable to store the common key Ka to the limited interrogator 10 by using a tamperproof technique.

First, the interrogator 10 performs the same processing as that described above in S1011 to S1013 in FIG. 4 (S2011 to S2013). To be specific, the interrogator 10 makes a request for the keyword KWi to the RFID tag 20 and receives the keyword KWi transmitted from the RFID tag 20 in response to the request. Then, the interrogator 10 computes the received keyword KWi and the common key Ka stored in the data storage unit 1500 with the same irreversible function H as that in S2001 in FIG. 6. The result of computation is obtained as the password PWi.

Next, the interrogator 10 transmits a command of reading/writing the password PWi calculated in S2013 and the RFID tag information or of invalidating the RFID tag 20 to the RFID tag 20 (S2014). In this case, it is recommended that the interrogator 10 and the RFID tag 20 be brought closer to each other while being separated away from the others, paying attention to prevent the communication data from being leaked and intercepted.

Next, on the RFID tag 20 side, the password PWi transmitted in S2014 is used to perform a processing which authenticates the interrogator 10 that has transmitted the password PWi and the command (S2015). If the interrogator 10 has not been successfully authenticated, the processing is terminated. If the authentication was successful, the processing proceeds to a processing in S2016.

To be specific, the control unit 2000 of the RFID tag 20 receives the password PWi and the command transmitted from the interrogator 10 via the transmitting/receiving unit 2100. Then, the control unit 2000 outputs the received password PWi to the authenticating unit 2300 to cause the authenticating unit 2300 to perform the authentication processing. The authenticating unit 2300 compares the received password PWi and the password PWi stored in the data storage unit 2200. When the two passwords PWi are identical, the authenticating unit 2300 judges that the authentication was successful to output the result of authentication to the control unit 2000 and then proceeds to a processing in S2016. On the other hand, when the two passwords PWi are not identical, the authenticating unit 2300 judges that the authentication has failed to output the result of authentication to the control unit 2000 and then terminates the processing.

In S2016, the control unit 2000 of the interrogator 10 performs a processing in accordance with the command received in S2014. For example, when the received command is a write command of the encrypted RFID tag information Ai, the control unit 2000 causes the data storage unit 2200 to store the encrypted RFID tag information Ai. For example, when the received command is a read command of the encrypted RFID tag information Ai in the data storage unit 2200, the control unit 2000 reads the encrypted RFID tag information Ai stored in the data storage unit 2200 and transmits the read encrypted RFID tag information Ai to the interrogator 10 via the transmitting/receiving unit 2100. For example, when the received command is a command of invalidating the RFID tag 20, the control unit 2000 performs a processing which invalidates the RFID tag 20.

As described above, by providing the function of authenticating the interrogator 10 for the RFID tag 20, the RFID tag 20 can accept a command of reading/writing information in the RFID tag 20 or of invalidating the RFID tag 20 only for the authenticated interrogator 10.

Thus, according to the second embodiment, in addition to the effect of the first embodiment described above, unauthorized access to the RFID tag 20 can be prevented.

### Third Embodiment

Next, a third embodiment of the present invention will be described. The third embodiment of the present invention is obtained by adding a function of updating the keyword KWi to be stored in the RFID tag 20 for each time to the configuration of the second embodiment. In the description of the third embodiment, the same reference numerals are used for the same configurations as those in the second embodiment described above.

A functional configuration of the third embodiment of the present invention is the same as that of the second embodiment except for a function of the control unit 1000. A hardware configuration of the third embodiment is the same as that of the second embodiment. Therefore, hereinafter, a different part will be mainly described. To be specific, the control unit 1000 of the interrogator 10 according to the third embodiment updates the keyword of the RFID tag 20 in the middle of or upon termination of a processing in S2011 to S2016 shown in FIG. 7.

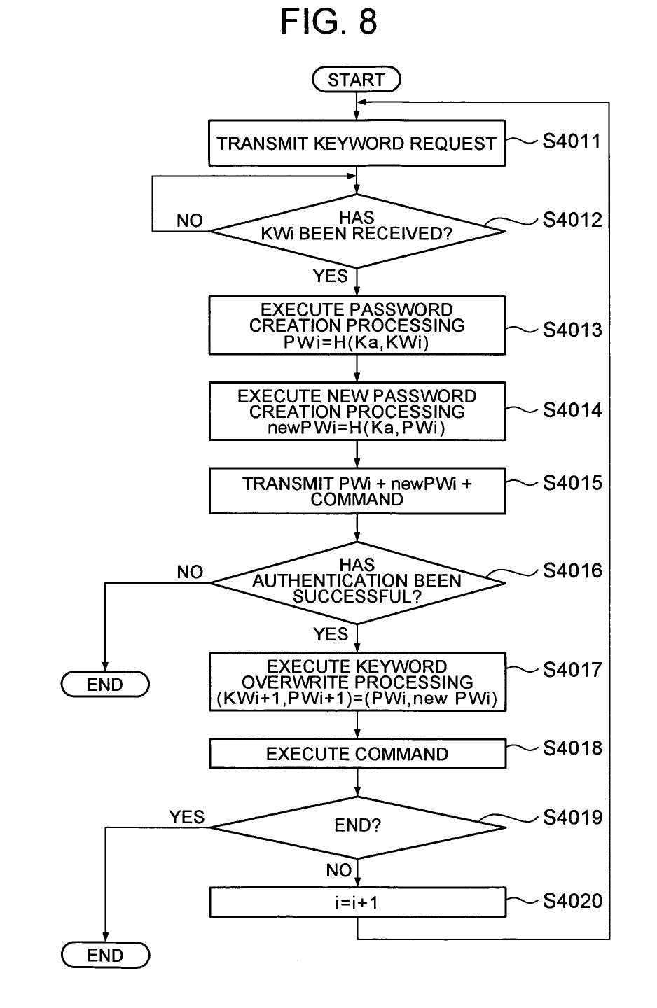

FIG. 8 is a flowchart for explaining a processing which updates the keyword 232 to be stored in the RFID tag 20, which is executed by the RFID tag system according to the third embodiment of the present invention.

First, the interrogator 10 performs the same processing as that in S2011 to S2013 in FIG. 7 described above (S4011 to S4013).

Next, upon creation of the password PWi in S4013, the interrogator 10 computes the created password PWi and the common key Ka with the same irreversible function H as that in S4013. The result of computation is obtained as a new password newPWi (S4014). To be specific, upon creation of the password PWi in S4013, the control unit 1000 of the interrogator 10 controls the password creating unit 1100 to create the new password newPWi in accordance with the above-described procedure.

Next, the interrogator 10 transmits the “password PWi” created in S4013, the “new password newPWi” created in S4014, and the “command” for reading/writing the RFID tag information or invalidating the RFID tag 20 to the RFID tag 20. At this time, it is recommended that the interrogator 10 and the RFID tag 20 be brought closer to each other while being separated from others to prevent the communication data from being leaked and intercepted (S4015).

Subsequently, the authentication processing is performed by the RFID tag 20 (S4016). Then, when the authentication is successful, the processing proceeds to S4017. If not successful, the processing is terminated. To be specific, the RFID tag 20 receives the “password PWi”, the “new password newPWi”, and the “command” transmitted from the interrogator 10 in S4015. Then, the authenticating unit 2300 of the RFID tag 20 compares the received “password PWi” and the “password PWi (the previously stored password)” stored in the data storage unit 2200 with each other. When the two passwords PWi are identical as a result of comparison, the authenticating unit 2300 judges that the authentication has been successful and outputs the result of authentication to the control unit 2000 and then transits to the processing in S4017. On the other hand, when the two passwords PWi are not identical, the authenticating unit 2300 judges that the authentication has failed and outputs the result of authentication to the control unit 2000 and then terminates the processing.

In S4017, a keyword overwrite processing is performed by the RFID tag 20. To be specific, the RFID tag 20 stores the “password PWi (the previously stored password)” stored in the data storage unit 2200 as a “keyword KWi+1”, and the “new password newPWi” received from the interrogator 10 in S4015 as a “password PWi+1” in the data storage unit 2200. In other words, the RFID tag 20 replaces the “keyword KWi” stored in the data storage unit 2200 with the stored “password PW”, and the stored “password PW” with the received “new password newPWi”.

Then, in accordance with the same procedure as that in S2016 shown in FIG. 7, the RFID tag 20 operates in accordance with the command received from the interrogator 10 in S4015 (S4018).

Thereafter, the interrogator 10 accepts a selection of the user of whether or not to continue the processing on the RFID tag 20. When the interrogator 10 accepts the selection of continuing the processing, the interrogator 10 returns to S4011. If not, the interrogator 10 terminates the processing.

By the above processing, by changing the keyword stored in the RFID tag 20, it is possible to make the tracking of the RFID tag 20 difficult. In the third embodiment, since the previously used password PW is used as a new keyword, a processing for newly creating the unique keyword KWi can be omitted to lower communication cost.

Although the previous password PWi is used as the new keyword KWi+1 in the above-described third embodiment, a new keyword may alternatively be created. To be specific, in S4014, the keyword KWi+1 may be newly created to be used to create the new password PWi+1. In this case, the reader/writer 10 transmits the “password PWi”, the “new password newPWi”, the “command”, and the “keyword KW+1” in S4015.

Then, the RFID tag 20 uses the received “password PWi” and the “password PWi” stored in itself to perform the authentication processing. If the authentication is successful, the RFID tag 20 updates, in S4017, the “password PW” and the “keyword KWi” stored in itself to the “new password newPWi” and the “keyword KW+1” transmitted from the interrogator 10. In this case, a method which creates a new keyword is not particularly limited. For example, random number generating means may be provided to the interrogator 10. A hash value obtained by assigning a random number generated by the random number generating means to a hash function may be used as the new keyword KWi+1.

### Fourth Embodiment

Next, a fourth embodiment of the present invention will be described. The fourth embodiment of the present invention is obtained by adding a function which checks the update of the keyword KWi to the configuration of the third embodiment. Such the configuration serves to prevent the interrogator 10 from making unauthorized access to the RFID tag 20.

A functional configuration of the fourth embodiment of the present invention is the same as that of the second embodiment shown in FIG. 5 except for a function of the control unit 1000. A hardware configuration of the fourth embodiment is the same as that of the second embodiment. Therefore, a different part will be mainly described below. To be specific, in the fourth embodiment, the control unit 2000 of the RFID tag 20 is provided with a counter which counts a number (a counter number will be described as a “Q value”), down-count means which decrements the counter value by one, count clear means which restore the counter value to an initial value upon update of the keyword 232 of the data storage unit 2200, and function stop means which invalidates the function of the RFID tag 20 when the counter indicates 0 or less. This configuration allows the interrogator 10 to prevent the keyword 232 from being obtained several times without being updated.

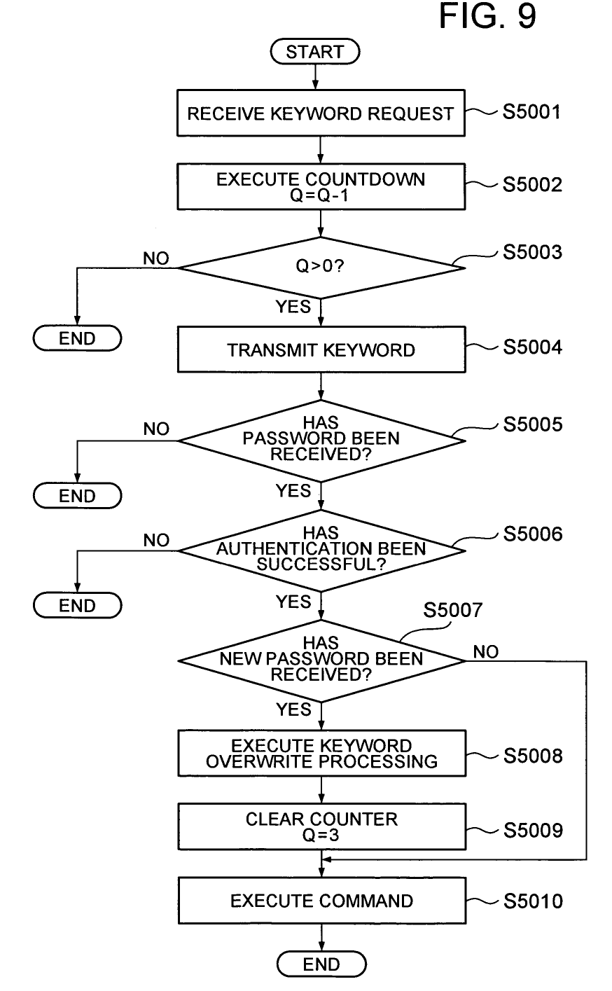

FIG. 9 is a flowchart for explaining a processing which checks whether or not the keyword 232 to be stored in the RFID tag 20 has been updated each time according to the fourth embodiment of the present invention.

For the counter of the control unit 2000 of the RFID tag 20, the “Q value” is set to “3” as the initial value. The following processing is started in a state where the counter is set to the initial value (“3”).

First, the RFID tag 20 receives a keyword request from the interrogator 10 (S5001). Then, upon reception of the keyword request from the interrogator 10, the RFID tag 20 decrements the Q value of the counter by one (S5002). To be specific, the control unit 2000 of the RFID tag 20 receives the keyword request transmitted from the interrogator 10 through the transmitting/receiving unit 2100. Then, upon reception of the keyword request, the control unit 2000 of the RFID tag 20 decrements the “Q value” of the counter by one with the down-count means.

Subsequently, the control unit 2000 of the RFID tag 20 checks whether the “Q value” of the counter is greater than “0” or not. When the “Q value” is greater than “0”, the control unit 2000 proceeds to S5004. On the other hand, when the “Q value” is equal to or smaller than “0”, the processing is terminated (S5003).

As described above, when the “Q value” of the counter becomes equal to or smaller than “0”, the function stop means of the control unit 2000 of the RFID tag 20 operates not to transmit the password to the interrogator 10. Even after the “Q value” became “0” or smaller, the RFID tag 20 may be restored to a normal status (a status where data can be read/written or the like) by the following manner. To be specific, the interrogator 10 transmits the correct password PWi and the new password newPWi to the RFID tag 20 now having the “Q value” of the counter being “0” or smaller (the interrogator 10 may also transmit the encrypted RFID tag information Ai with the password PWi and the new password newPWi). Upon reception of the correct password PWi and the new password newPWi from the interrogator 10, the RFID tag 20 transits to S5008 to update the keyword KWi and the password PWi stored in the data storage unit 2200 to restore the Q value to the initial value. When the RFID tag 20 receives the encrypted RFID tag information Ai, the received encrypted RFID tag information Ai is also stored in the data storage unit 2200.

Next, a processing in S5004, to which the processing proceeds when the “Q value” is judged in S5003 as being larger than “0”, will be described. In S5004, the RFID tag 20 returns the keyword KWi to the interrogator 10. To be specific, the control unit 2000 of the RFID tag 20 reads the keyword KWi stored in the data storage unit 2200 and transmits the read keyword KWi to the interrogator 10. Upon transmission of the keyword KWi from the RFID tag 20, the interrogator 10 performs the processing in S4012 through S4015 in FIG. 8.

The control unit 2000 of the RFID tag 20 waits for the reception of the password from the interrogator 10. When the control unit 2000 of the RFID tag 20 does not receive the password after waiting for a predetermined period of time, the processing is terminated. When the control unit 2000 of the RFID tag 20 receives the password within the predetermined period of time, the processing proceeds to S5006 (S5005). Upon transmission of the password, the interrogator 10 transmits the new password and the command. In this step, the control unit 2000 of the RFID tag 20 receives the new password newPWi and the command with the password PWi.

The control unit 2000 of the RFID tag 20 compares the password received from the interrogator 10 and the password stored in the data storage unit 2200 of the RFID tag 20 with each other. When the two passwords are identical, the control unit 2000 judges that the authentication has been successful to proceed to S5007. When the two passwords are not identical, the processing is terminated in this step (S5006).

Next, the control unit 2000 of the RFID tag 20 checks whether or not the new password received in S5005 and the current password stored in itself differ from each other. When the new password differs from the current password, the processing proceeds to S5008. On the other hand, when the new password is identical to the current password, the control unit 2000 of the RFID tag 20 transits to S5010 (S5007). Even when the control unit 2000 has not received the new password in S5005, the control unit 2000 transits to S5010.

In S5008, the RFID tag 20 updates the keyword and the password stored in the data storage unit 2200 in accordance with the same procedure as that in S4017 shown in FIG. 8 (S5008).

Next, the RFID tag 20 restores the “Q value” of the counter to the initial value. In this embodiment, the “Q value” is restored to “3” (S5009). To be specific, the count clear means of the control unit 2000 of the RFID tag 20 restores the counter to the initial value.

In S5010, the RFID tag 20 responds to a request for the RFID tag information or executes a command (S5010).

By the above processing, it is possible to check whether or not the keyword to be stored in the RFID tag has been updated to prevent the keyword of the RFID tag 20 from being obtained several times without being updated.

Even when the RFID tag 20 according to the present invention successively receives erroneous passwords several times (“three times” in the above-described example), the “Q value” of the counter becomes “0” or smaller. As a result, the function stop means of the control unit invalidates the function of the RFID tag 20. Therefore, even if the RFID tag 20 is subjected to a fraud corresponding to the repeated transmission of the password by brute force attack or the like, the possibility that the stored data may be read can be lowered.

### Fifth Embodiment

Subsequently, a fifth embodiment of the present invention will be described. In the fifth embodiment, the keyword unique to the RFID tag is transmitted from the RFID tag to the interrogator 10 in a communication method different from that used for the other data in any of the above-described first to fourth embodiments. For convenience of the description, a variation of the second embodiment will be described below as an example. In the description of the fifth embodiment, same reference numerals are used for the same configuration as that of the second embodiment described above.

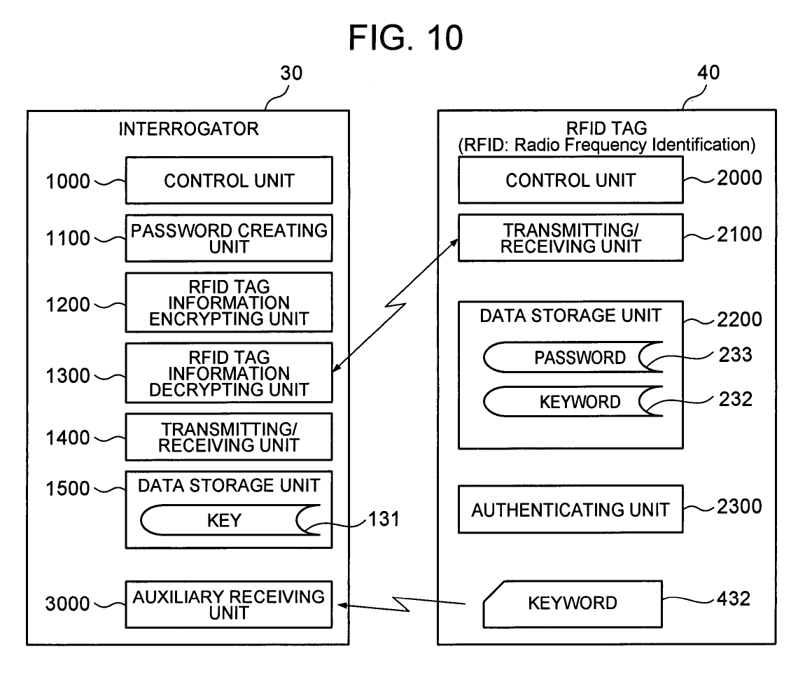

First, a functional configuration of the fifth embodiment will be described with reference to FIG. 10.

FIG. 10 is a functional block diagram of an RFID tag system according to the fifth embodiment of the present invention. As illustrated, the RFID tag system includes a interrogator 30 and an RFID tag 40. As in the second embodiment, the interrogator 30 includes the control unit 1000, the password creating unit 1100, the RFID tag information encrypting unit 1200, the RFID tag information decrypting unit 1300, the transmitting/receiving unit 1400, and the data storage unit 1500. Further, the interrogator 30 also includes an auxiliary receiving unit 3000 which receives a signal from the RFID tag 40 in an optical communication method, or the like.

As in the second embodiment, the RFID tag 40 includes the control unit 2000, the transmitting/receiving unit 2100, the data storage unit 2200, and the authenticating unit 2300. Instead of causing the data storage unit 2200 to store the unique keyword, the RFID tag 40 prints, for example, the keyword 432 on a label or the like in a barcode format to attach the obtained label to the RFID tag 40.

Then, the auxiliary receiving unit 3000 of the interrogator 30 reads the keyword 432 in the barcode format printed on the label or the like, and outputs the read keyword 432 to the control unit 1000. A specific processing performed in the fifth embodiment will be described in detail below.

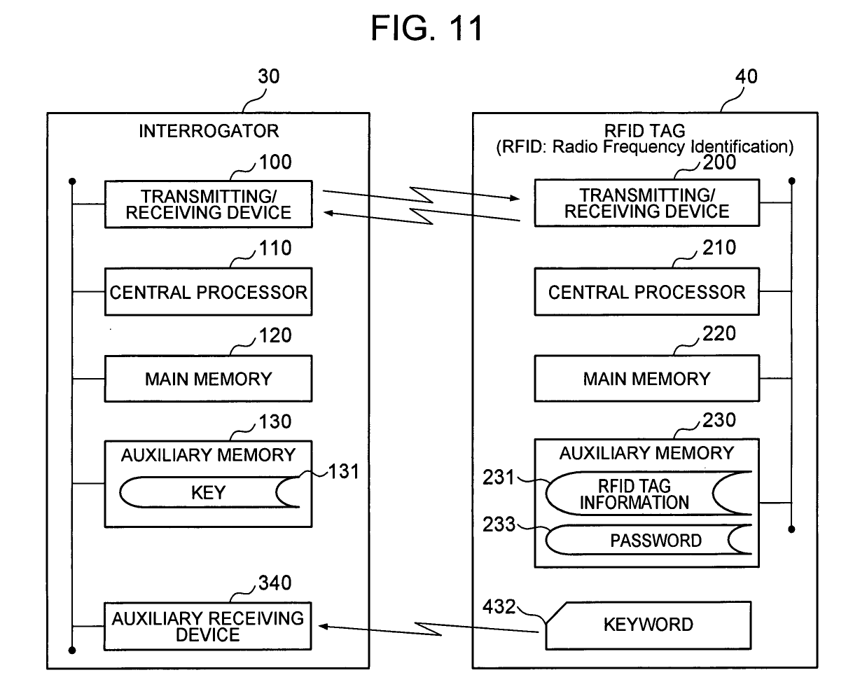

Subsequently, a hardware configuration of the fifth embodiment is shown in FIG. 11.

As illustrated, as in the second embodiment, the interrogator 30 includes the transmitting/receiving device 100, the central processor 110, the main memory 120, and the auxiliary memory 130. Further, the interrogator 30 includes an auxiliary receiving device 340 such as a barcode reader device, which receives a signal from the RFID tag 40 in the optical communication method or the like. A function of the auxiliary receiving unit 3000 is realized by the auxiliary receiving device 340. The RFID tag 40 is the same as the RFID tag 20 in the second embodiment except that the label with the data indicating the keyword 432 being printed in the barcode format or the like is attached thereto.

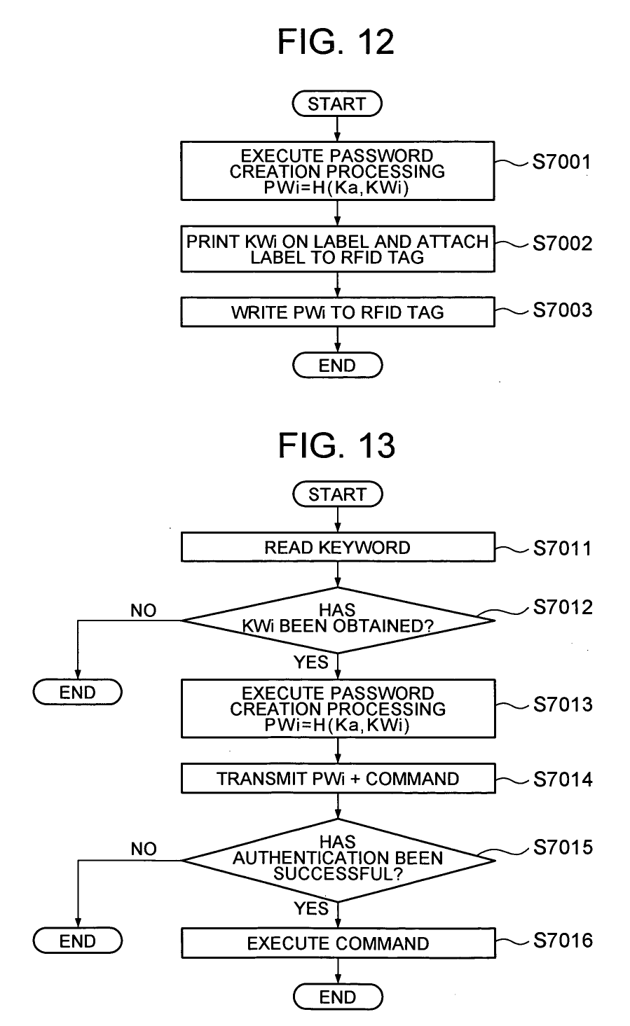

Subsequently, a processing executed in the fifth embodiment will be described with reference to FIGS. 12 and 13.

First, a processing of the interrogator 30 in a preliminary stage, in which the password 433 required for authenticating the interrogator 30 is written to the RFID tag 40, will be described.

FIG. 12 is a flowchart of the processing in the preliminary stage which is executed by the interrogator according to the fifth embodiment of the present invention.

First, in accordance with the same procedure as that in S2001 shown in FIG. 6, the interrogator 30 creates the password PWi (S7001). To be specific, the password creating unit 1100 computes the keyword KWi unique to the RFID tag and the common key Ka with the irreversible function H to create the password PWi.

Next, the interrogator 30 prints the keyword KWi used in S7001 on a label or the like in, for example, the barcode format. The printed label is attached by the user at a predetermined position of the RFID tag 40 (S7002). A method which prints the keyword on the label or the like in the barcode format is not particularly limited. For example, the keyword KWi is input to an information processing apparatus such as a personal computer to cause the information processing apparatus to create the printed data indicating the keyword in the barcode format. Then, the information processing apparatus may use a printer connected thereto to print the printed data on the label.

Next, the interrogator 30 transmits and writes the password PWi to the RFID tag 40. In this case, the interrogator 30 and the RFID tag 40 are brought closer to each other while being separated from others to prevent the communication data from being leaked and intercepted (S7003).

Subsequently, a processing, in which the interrogator 30 operates the RFID tag 40 according to the fifth embodiment, will be described with reference to FIG. 13.

FIG. 13 is a flowchart for explaining a data transmission/reception processing performed between the interrogator and the RFID tag according to the fifth embodiment.

The illustrated flow is executed by the interrogator 30 different from the interrogator 30 which wrote the password PWi to the RFID tag 40 in the preliminary stage processing shown in FIG. 12.

The interrogator 30 which executes this flow stores the same common key Ka as that used in S7001 shown in FIG. 12. To be specific, the data storage unit 1500 of the interrogator 30 stores the common key Ka used in S7001. In this case, it is desirable to store the common key Ka in the limited interrogator 30 by using a tamper proof technique.

First, the interrogator 30 reads the keyword from the label attached to the RFID tag 40 (S7011). To be specific, the auxiliary receiving unit 3000 of the interrogator 30 reads the keyword from the label attached to the RFID tag 40.

Next, the interrogator 30 judges whether or not the keyword can be read from the RFID tag 40. When the keyword was successfully read, the processing proceeds to S7013. When the keyword cannot be read, the processing is terminated (S7012). To be specific, when the keyword was successfully read, the auxiliary receiving unit 3000 transmits the read signal to the control unit 1000. When receiving the keyword from the auxiliary receiving unit 3000, the control unit 1000 proceeds to S7013. On the other hand, when the auxiliary receiving unit 3000 cannot read the keyword, the auxiliary receiving unit 3000 outputs a signal indicating the reading has failed to the control unit 1000 and then terminates the processing.

In S7013, a processing which creates the password is executed by the password creating unit 1100. To be specific, the control unit 1000 transmits the keyword from the auxiliary receiving unit 3000 to the password creating unit 1100 to cause the password creating unit 1100 to create the password. The password creating unit 1100 creates the password PWi in accordance with the same procedure as that in S2013 shown in FIG. 7 above (S7013).

Thereafter, the same processing steps as S2015 and S2016 in FIG. 7 above are executed to then terminate the processing (S7014 to S7016).

By the above processing, even in the fifth embodiment, the same effect as that in the second embodiment described above can be obtained.

As described above, according to the first through fifth embodiments described above, a highly secure RFID tag system can be provided at low cost without providing a complicated logic circuit which performs the encryption processing or the decryption processing for the side of the RFID tag.

The present invention is not limited to the above-described embodiments. Various modifications are possible within the scope of the gist of the present invention.

For example, a configuration which selects appropriate one from a plurality of common keys may be added to the above-described first to fifth embodiments. To be specific, the data storage unit 1500 of the interrogator 10 is caused to store relational information between at least one keyword and the common key 131 corresponding to the keyword. The interrogator 10 is provided with key extraction means which uses the relational information to extract the common key 131 corresponding to the keyword 232 received from the RFID tag 20 from the plurality of common keys.

When a plurality of the interrogators 10 are used, they share relational information between at least one keyword KWi and the common key Ka corresponding to each keyword KWi. In this case, it is desirable to store the relational information in the limited interrogator 10 using a tamper proof technique. Alternatively, it is desirable to collectively manage the relational information to allow each of the interrogators 10 to obtain the relational information over a secure network.

Then, in the processing by the interrogator 10 in the preliminary stage where the keyword 232 is written to the RFID tag 20, relational information between the unique keyword KWi and the arbitrary common key Ka is first stored in the interrogator 10 to allow the relational information to be shared between the limited interrogators 10.

In the processing by the interrogator 10 in the stage where the keyword KWi is obtained from the RFID tag 20 to create the password PWi, the common key Ka corresponding to the received keyword KWi is extracted from the relational information to be computed with the irreversible function H to create the password PWi. By the above processing, the keys can be distributed to reduce the risk caused by the leakage of the common key.

For example, in any one of the first to fifth embodiments described above, instead of computing and creating the password in the interrogator, a database which associates the common key, the keyword and the password with one another may be used to derive the password. In this case, in place of the password creating means which computes the keyword 232 unique to the RFID tag and the common key 131 with the irreversible function H to create the password, a database which associates the keyword 232 unique to the RFID tag, the common key 131 and the password 233 with one another and means which derives the password from the database are provided for the interrogator 10. With the above-described configuration, the risk caused by the leakage of the common key can be avoided.

Furthermore, for example, in any of the first to fifth embodiments described above, instead of computing and creating the password in the interrogator, the password may be obtained from a server over a secure network. In this case, the interrogator is provided with means which is connected to the server over the secure network to obtain the password from the server. Even in this manner, the risk caused by the leakage of the common key can be avoided.

In the above description of the third embodiment, the keyword KWi is updated when the interrogator 10 accesses the RFID tag 20 in the second embodiment, specifically, in the configuration which performs the authentication processing on the RFID tag 20 side. However, the configuration which updates the keyword KWi may be applied to the first embodiment. In this case, the keyword is updated in the first embodiment, for example, in the following manner.

To be specific, after the interrogator 10 reads the encrypted RFID tag information Ai from the RFID tag 20 to execute the decryption processing (S1016 in FIG. 4), the reader/writer 10 uses the password PWi used for the decryption processing as a new “keyword KWi+1”. Thereafter, in accordance with the same procedure as that in S4014 in FIG. 8, the interrogator 10 creates the new password newPWi and then uses the created new password newPWi as a parameter to encrypt the RFID tag information in accordance with the procedure in S1002 shown in FIG. 3. Then, the interrogator 10 rewrites the “encrypted RFID tag information Ai” and the “keyword KWi” stored in the RFID tag 20 to the “encrypted RFID tag information Ai” encrypted with the new password newPWi and to the new “keyword KWi+1”.

Even in the case where the interrogator 10 writes another encrypted RFID tag information without executing the processing which reads the encrypted RFID tag information Ai from the RFID tag 20, the processing in S4014 shown in FIG. 8 is performed for each data to be written to encrypt the data to be written by using the new password newPWi. Then, the interrogator 10 writes the encrypted data to the RFID tag 20 to update the keyword stored in the RFID tag 20 to the new “keyword KWi+1”.

Even in the case where the keyword is updated in the first embodiment, a new keyword may be created without using the previous password PWi as the new keyword KWi+1.

Although the case where the common key is used to create the password has been given as an example in the above-described embodiments, the present invention is not limited thereto. Any data may be used as long as the data can be managed not to be leaked to a third party.

What is claimed is:

1. An RFID tag system, comprising:
an RFID tag including a memory which stores data; and
a interrogator which writes/reads data to/from the memory of the RFID tag,
wherein the RFID tag includes:
a first transmitting/receiving unit which transmits/receives data to/from the interrogator; and
a first control unit which accepts various commands from the interrogator through the first transmitting/receiving unit to perform a processing corresponding to the accepted command,
wherein the interrogator includes:
a password creating unit which computes a prestored electronic key and a keyword unique to the RFID tag with a predetermined irreversible function to create a password;
an encryption processing unit which uses the password as a parameter to encrypt information regarding a target (target information) attached with the RFID tag by using a predetermined encryption function;
a decryption processing unit which uses the password as a parameter to decrypt the encrypted target information by using a predetermined decryption function corresponding to the predetermined encryption function;
a second transmitting/receiving unit which transmits/receives the data to/from the RFID tag; and
a second control unit which transmits various commands to the RFID tag through the second transmitting/receiving unit to perform a processing which reads/writes the data from/to the memory of the RFID tag and a processing which invalidates the RFID tag, and
wherein the second control unit of the interrogator writes the encrypted target information and the keyword unique to the RFID tag to the memory of the RFID tag, reads the encrypted target information and the keyword unique to the RFID tag written in the memory of the RFID tag, causes the password creating unit to create the password by using the read keyword and the electronic key, and causes the decryption processing unit to decrypt the read encrypted target information into plaintext target information by using the created password.

2. The RFID tag system according to claim 1,
wherein the memory of the RFID tag further stores the password created by the password creating unit,
wherein, upon transmission of any one of a command which reads the encrypted target information stored in the memory of the RFID tag, a command which writes the encrypted target information to the memory of the RFID tag, and a command which invalidates the RFID tag to the RFID tag, the second control unit of the interrogator reads the keyword stored in the memory of the RFID tag, causes the password creating unit to create the password by using the read keyword and the stored electronic key, and transmits the created password and the any one of the commands to the RFID tag, and
wherein the first control unit of the RFID tag accepts the password and the command transmitted from the interrogator through the first transmitting/receiving unit, compares the password stored in the memory and the accepted password, and performs a processing corresponding to the accepted command when the two passwords are identical with each other.

3. The RFID tag system according to claim 1,
wherein the memory of the RFID tag further stores the password created by the password creating unit,
wherein, upon transmission of any one of a command which reads the encrypted target information stored in the memory of the RFID tag, a command which writes the encrypted target information to the memory of the RFID tag, and a command which invalidates the RFID tag to the RFID tag, the second control unit of the interrogator reads the keyword stored in the memory of the RFID tag, causes the password creating unit to create a password (a first password) by using the read keyword and the stored electronic key and a password different from the first password (a second password) by using the first password and the electronic key, and transmits the first and second passwords and the any one of the commands to the RFID tag, and
wherein the first control unit of the RFID tag accepts the first and second passwords and the command transmitted from the interrogator through the first transmitting/receiving unit, judges whether or not the password stored in the memory and the accepted first password are identical with each other, and updates the keyword stored in the memory to the first password and the password stored in the memory to the second password and further performs a processing corresponding to the accepted command when it is judged that the two passwords are identical.

4. The RFID tag system according to claim 2,
wherein the second control unit of the interrogator creates a new keyword and updates the keyword stored in the memory of the RFID tag to the new keyword when the RFID tag performs the processing corresponding to the accepted command.

5. The RFID tag system according to claim 2,
wherein the RFID tag includes a counter which counts a number when accepting the command from the interrogator and clears the counted number when updating the keyword stored in the memory, and
wherein the first control unit refers to a value of the counter when accepting the command from the interrogator and does not perform the processing corresponding to the accepted command when the value exceeds a predetermined value.

6. A data processing method executed by an RFID tag system comprising: an RFID tag including a memory which stores data; and a interrogator which reads/writes data from/to the memory of the RFID tag,
wherein the RFID tag includes a first transmitting/receiving unit which transmits/receives data to/from the interrogator, and the RFID tag accepts various commands from the interrogator through the first transmitting/receiving unit to perform a processing corresponding to the accepted command,
wherein the interrogator includes: a password creating unit which computes a prestored electronic key and a keyword unique to the RFID tag with a predetermined irreversible function to create a password; an encryption processing unit which uses the password as a parameter to encrypt information regarding a target (target information) attached with the RFID tag by using a predetermined encryption function; a decryption processing unit which uses the password as a parameter to decrypt the encrypted target information by using a predetermined decryption function corresponding to the predetermined encryption function; and a second transmitting/receiving unit which transmits/receives the data to/from the RFID tag, and the interrogator transmits various commands to the RFID tag through the second transmitting/receiving unit to perform a processing which reads/writes the data from/to the memory of the RFID tag and a processing which invalidates the RFID tag, and
wherein the interrogator executes the steps of:
writing the encrypted target information and the keyword unique to the RFID tag to the memory of the RFID tag;
reading the encrypted target information and the keyword unique to the RFID tag written in the memory of the RFID tag;
causing the password creating unit to create the password by using the read keyword and the electronic key; and
causing the decryption processing unit to decrypt the read encrypted target information to plaintext target information by using the created password.

7. The data processing method executed by the RFID tag system according to claim 6,
wherein the memory of the RFID tag further stores the password created by the password creating unit,
wherein, upon transmission of any one of a command which reads the encrypted target information stored in the memory of the RFID tag, a command which writes the encrypted target information to the memory of the RFID tag, and a command which invalidates the RFID tag to the RFID tag, the interrogator executes the steps of:
reading the keyword stored in the memory of the RFID tag;
causing the password creating unit to create the password by using the read keyword and the stored electronic key; and
transmitting the created password and the any one of the commands to the RFID tag, and
wherein the RFID tag executes the steps of:
accepting the password and the command transmitted from the interrogator through the first transmitting/receiving unit; and
comparing the password stored in the memory and the accepted password to perform a processing corresponding to the accepted command when the two passwords are identical with each other.

8. The data processing method executed by the RFID tag system according to claim 6,
wherein the memory of the RFID tag further stores the password created by the password creating unit,
wherein, upon transmission of any one of a command which reads the encrypted target information stored in the memory of the RFID tag, a command which writes the encrypted target information to the memory of the RFID tag, and a command which invalidates the RFID tag to the RFID tag, the interrogator executes the steps of:
reading the keyword stored in the memory of the RFID tag;
causing the password creating unit to create a password (a first password) by using the read keyword and the stored electronic key and a password different from the first password (a second password) by using the first password and the electronic key; and
transmitting the first and second passwords and the any one of the commands to the RFID tag, and
wherein the RFID tag executes the steps of:
accepting the first and second passwords and the command transmitted from the interrogator through the first transmitting/receiving unit; and
judging whether or not the password stored in the memory and the accepted first password are identical with each other to update the keyword stored in the memory to the first password and the password stored in the memory to the second password and further to perform a processing corresponding to the accepted command when it is judged that the two passwords are identical.
